(19) United States
(12) Patent Application Publication
(10) Pub. No.: US 2026/0322162 A1
(43) Pub. Date: Oct. 15, 2026

(54) METHOD AND RECONFIGURABLE INTELLIGENT SURFACE UNIT FOR HARVESTING ENERGY

(71) Applicant: Telefonaktiebolaget LM Ericsson (publ), Stockholm (SE)

(72) Inventors: Morteza ESMAEILI TAVANA, Sundbyberg (SE); Meysam MASOUDI, Stockholm (SE); Emil BJÖRNSON, Hägersten (SE)

(73) Assignee: Telefonaktiebolaget LM Ericsson (publ), Stockholm (SE)

(21) Appl. No.: 19/478,941

(22) PCT Filed: Apr. 28, 2023
(86) PCT No.: PCT/SE2023/050410

§ 371 Date: Oct. 27, 2025

(51) Int. Cl. H02J 50/00; H01Q 1/24; H01Q 3/44; H04B 7/04

(52) U.S. Cl. CPC H02J 50/001; H01Q 1/248; H01Q 3/44; H04B 7/04013

(57) ABSTRACT

Disclosed is a method performed by a Reconfigurable Intelligent Surface, RIS, unit (120) of a wireless communication network (100), for harvesting energy to a RIS (121), the RIS comprising a plurality of reflective elements (124). The method comprises measuring received power for a combined signal, combined by signals received at each of the plurality of reflective elements (124), for two or more phase settings for one reflective element, and determining a phase setting for the one reflective element that results in highest received power for the combined signal based on the measurements at the two or more phase settings. Those steps are repeated for each reflective element (124), applying the determined phase settings for the already treated reflective elements. The power received for the combined signal is caught by an energy harvesting device (127) of the RIS unit (120) and stored in a power supply (128) of the RIS unit (120).

### TECHNICAL FIELD

The present disclosure relates generally to methods and Reconfigurable Intelligent Surface (RIS) units of a wireless communication network for harvesting energy to the RIS unit from wireless signals sent to the RIS. The present disclosure further relates to computer programs and carriers corresponding to the above methods and RIS units.

### BACKGROUND

In wireless communication networks, the number of wireless communication devices, aka wireless devices, is increasing day by day as well as demand for higher throughput. Consequently, there is an ongoing search for physical-layer technologies that can play a role in increasing the throughput over the air interface between wireless devices and network nodes, i.e., base stations.

One such technology that is up for discussion is to use Intelligent Reflective Surfaces (IRS), also known as Reconfigurable Intelligent Surfaces (RIS) in wireless communication networks. A RIS is a means to control the propagation environment of a wireless communication link, i.e., air interface, between a transmitter and a receiver, for example between a network node and a wireless device. A RIS is a low-cost and low-complexity passive signal reflector comprising a multitude of reflective elements that can be configured to have different impedance, i.e., phase setting and possibly also amplitude setting incurred by an individual element. The impedance pattern of the RIS determines how incident waves are reflected/scattered. A RIS is usually planar and used to redirect the signal propagation path to, e.g., overcome mid-term link blockages. That is, whenever a direct link between a transmitter and a receiver is blocked, e.g., by a building, the signal can take an indirect route in two stages: transmitter-to-RIS and RIS-to-receiver. This is discussed in “Reconfigurable Intelligent Surfaces: Three myths and two critical questions”, by Björnson et al., published in IEEE Communications magazine 58. 12, year 2020, pages 90-96.

The RIS is an alternative to the traditional relays. The RIS can operate in full duplex. The RIS lacks power amplification. The RIS compensates by having a larger physical size than a relay. The RIS comprises a plurality of antenna-sized reflective elements. As mentioned, each reflective element is instructed to apply a certain phase shift to the incident electromagnetic waves, such that the phase-shifted waves after being reflected at the RIS combine constructively at the intended receiver antenna(s).

“Beyond massive MIMO: The potential of data transmission with large intelligent surfaces”, by S. Hu et al, published in IEEE Trans. Signal Process., vol. 66, no. 10 pp. 2746-2758 May 2018, describes how a RIS can be used to assist communication to increase received signal-to-noise ratio (SNR) and how a RIS can be used to significantly reduce energy consumption. “Reconfigurable intelligent surfaces for energy efficiency in wireless communication”, by C. Huang et al, published in IEEE Transactions on Wireless Communications vol. 18 no. 8 pp 4157-4170, 2019, presents two RIS-based methods using known channel state information (CSI) for energy efficiency maximization of downlink Multiple Input Single Output (MISO) systems.

A main difference between a RIS and a relay is that the RIS does not have any transceiver. Therefore, the RIS can potentially consume much less energy compared to the relay. However, despite the lack of active amplification in a RIS, it has some power consumption, and hence a power supply is still needed. This power can be supplied by harvesting energy from ambient sources, i.e., by harvesting energy from electromagnetic waves transmitted over the air from transmitters, which is one step toward self-sustainable communication networks. The harvested energy can be used by the RIS for its operation and therefore its energy dependence on external sources can be decreased or even eliminated, which in turn increases the energy efficiency of the wireless communication network. Also, if the RIS can support itself with energy via energy harvesting, the RIS can be employed in places where it is impossible or at least very expensive to have the RIS connected to an electrical power network for power supply.

“Wireless energy harvesting for autonomous reconfigurable intelligent surfaces” by Ntontin et al., published in IEEE Transactions on green communications and networking, Vol. 7, No. 1, March 2023, pages 114-129 discusses energy harvesting to a RIS from signals sent by a transmitter using channel state information (CSI) as an input. The CSI comes from estimation of a transmitter-RIS-receiver communication channel but does not provide any mechanism to obtain information of the transmitter-RIS communication channel. In order to acquire CSI of the transmitter-RIS communication channel, i.e., the communication channel between the transmitter and the RIS, there need to be coordination between the transmitter and the RIS. For this reason, signaling comprising reference signals is needed between the transmitter and the RIS, which requires the RIS to be equipped with extra hardware, such as a transceiver including a Radio Frequency (RF) chain. Further, to obtain CSI, such an RF chain needs to measure both amplitude and phase. Therefore, such prior art solutions are difficult to use along with energy detectors. Further, for energy harvesting at a RIS using today's methods, one energy harvesting unit is needed per reflective element. This requires lot of extra hardware components at a RIS as a typical RIS contains hundreds of reflective elements. Further, extra hardware at the RIS results in higher energy consumption, which lowers the aid of the energy harvesting and the possibility to make the RIS self-supporting regarding energy. Consequently, there is a need for a method that can harvest energy at a RIS in a more energy-efficient way.

### SUMMARY

It is an object of embodiments of the invention to provide a RIS that can harvest energy from ambient sources in a more efficient way. It is another object of embodiments to provide a RIS that can harvest energy efficiently from wireless signals transmitted to the RIS. It is possible to achieve at least one of these objects by using methods and RISs as defined in the attached independent claims.

According to one aspect, a method is provided that is performed by a RIS unit of a wireless communication network, for harvesting energy. The RIS unit comprises a RIS that has a plurality of reflective element units. Each of the plurality of reflective element units is independently controllable regarding phase setting and is independently controllable in relation to the other of the plurality of reflective element units. The method comprises obtaining, from the wireless communication network, information that the RIS unit is to operate in an energy harvesting mode. The method further comprises, after the obtaining, measuring a resulting power-related quantity of one or more wireless signals received by the RIS from one or more transmitters, when one of the plurality of reflective element units has a first phase setting, the resulting power-related quantity being a power-related quantity of a combined signal combined by the one or more wireless signals received at the plurality of reflective element units. The method further comprises changing phase setting of the one of the plurality of reflective element units from the first phase setting to a second phase setting different from the first phase setting and measuring the resulting power-related quantity when the one reflective element unit has the second phase setting. The method further comprises determining a preferred phase setting for the one reflective element unit based on the measured resulting power-related quantity for the first and second phase settings, the preferred phase setting being determined to give a highest possible resulting power for the combined signal, and applying the determined preferred phase setting for the one reflective element unit. The method further comprises performing, for each of the plurality of reflective element units, one after the other, and with the applied determined preferred phase settings, the steps of measuring the resulting power-related quantity for the first phase setting, changing phase setting to the second phase setting, measuring the resulting power-related quantity for the second phase setting, determining the preferred phase setting based on the measured resulting power-related quantity for the first and second phase settings, and applying the determined preferred phase setting. The method further comprises storing the resulting power of the combined signal at the power supply of the RIS unit.

According to another aspect, a RIS unit is provided configured to operate in a wireless communication network and configured for harvesting energy. The RIS unit comprises a RIS that has a plurality of reflective element units. Each of the plurality of reflective element units is independently controllable regarding phase setting and is independently controllable in relation to the other of the plurality of reflective element units. The RIS unit comprises a processing circuitry and a memory, said memory contains instructions executable by said processing circuitry, whereby the RIS unit is operative for obtaining, from the wireless communication network, information that the RIS unit is to operate in an energy harvesting mode. The RIS unit is further operative for, after the obtaining, measuring a resulting power-related quantity of one or more wireless signals received by the RIS from one or more transmitters, when one of the plurality of reflective element units has a first phase setting, the resulting power-related quantity being a power-related quantity of a combined signal combined by the one or more wireless signals received at the plurality of reflective element units, changing phase setting of the one of the plurality of reflective element units from the first phase setting to a second phase setting different from the first phase setting, and measuring the resulting power-related quantity, when the one reflective element unit has the second phase setting. The RIS unit is further operative for determining a preferred phase setting for the one reflective element unit based on the measured resulting power-related quantity for the first and second phase settings, the preferred phase setting being determined to give a highest possible resulting power for the combined signal. The RIS unit is further operative for applying the determined preferred phase setting for the one reflective element unit. The RIS unit is further operative for performing, for each of the plurality of reflective element units, one after the other, and with the applied determined preferred phase settings, the steps of measuring the resulting power-related quantity for the first phase setting, changing phase setting to the second phase setting, measuring the resulting power-related quantity for the second phase setting, determining the preferred phase setting based on the measured resulting power-related quantity for the first and second phase settings, and applying the determined preferred phase setting. The RIS unit is further operative for storing the resulting power of the combined signal at a power supply of the RIS unit.

According to other aspects, computer programs and carriers are also provided, the details of which will be described in the claims and the detailed description.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a schematic block diagram of a RIS in a wireless communication network in which the RIS is used in signal reflecting mode.

FIG. 2 is a schematic block diagram of an exemplary RIS in a wireless communication network in which the exemplary RIS is adapted for energy harvesting mode.

FIG. 3 is a flow chart illustrating a method performed by a RIS unit, according to possible embodiments.

FIG. 4 is a schematic block diagram of a RIS unit according to possible embodiments.

FIG. 5 is another flow chart illustrating a method performed by a RIS unit, according to possible embodiments.

FIG. 6 is a schematic diagram of a second type of RIS adapted for energy harvesting mode.

FIG. 7 is a schematic diagram of a first type of RIS adapted for energy harvesting mode.

FIG. 8 is a block diagram illustrating a RIS unit in more detail, according to further possible embodiments.

### DETAILED DESCRIPTION

Embodiments of the invention is built on the inventors' idea of maximizing received signal power at an energy detector from signals sent by one or more transmitters by aligning the phases of the reflective elements of the RIS. This only requires measurements of a power-related quantity such as signal strength at the RIS. Embodiments first aligns, or adjusts, phase of one reflective element, or reflective element unit, of a plurality of reflective elements or element units, according to measurements of a resulting power-related quantity so that the resulting received signal power at the RIS is maximized. Then phase is aligned for following reflective elements or element units, one by one, until all the reflective elements or element units of the plurality of reflective elements are aligned. According to embodiments, this process can be repeated until a stopping criterium is met. The resulting received power is harvested by an energy harvesting unit situated at the RIS or close to the RIS.

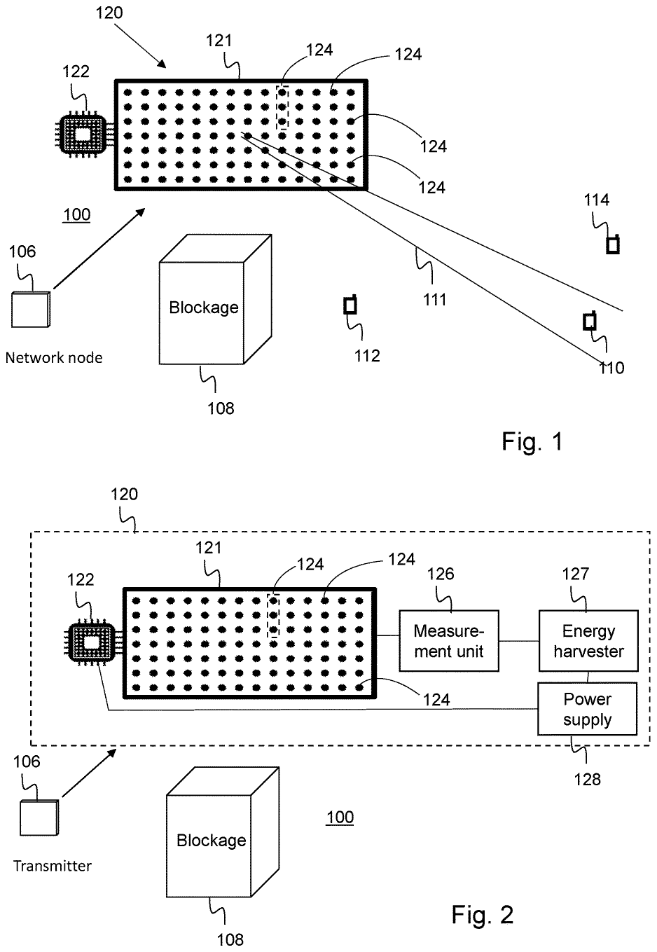

FIG. 1 shows a wireless communication network 100 comprising a radio access network (RAN) node aka network node 106 that is in, or is adapted for, wireless communication with one or more wireless communication devices aka wireless device 110, 112, 114. The wireless communication network 100 further comprises a RIS unit 120. The RIS unit 120 comprises a RIS 121 that has a plurality of reflective element units 124. The RIS unit 120 further comprises a RIS controller 122 that controls functions of the RIS unit. FIG. 1 shows the RIS unit 120 when being used for “intelligently” reflecting signals sent by the network node 106 and aimed for a certain wireless device 110 of the one or more wireless device so that the signals are reflected towards the certain wireless device 110. Individual phase settings are applied to the reflective element units 124 in order to form a beam 111 reflected from the RIS 121 so that it is directed towards the certain wireless device 110. This is a regular use of the RIS unit 120, in the following such regular use is called a “reflecting mode” of the RIS unit 120. Such a RIS unit 120 is for example used when there is a blockage 108 between the network node 106 and the one or more wireless device 110, 112, 114 so that signals from the network node 106 have difficulties to reach the one or more wireless device 110, 112, 114 when transmitted directly from the network node 106 towards the one or more wireless device.

The wireless communication network 100 may be any kind of wireless communication network that can provide radio access to wireless devices. Example of such wireless communication networks are networks based on Global System for Mobile communication (GSM), Enhanced Data Rates for GSM Evolution (EDGE), Universal Mobile Telecommunications System (UMTS), Code Division Multiple Access 2000 (CDMA 2000), Long Term Evolution (LTE), LTE Advanced, Wireless Local Area Networks (WLAN), Worldwide Interoperability for Microwave Access (WiMAX), WiMAX Advanced, as well as fifth generation (5G) wireless communication networks based on technology such as New Radio (NR), and any possible future sixth generation (6G) wireless communication network.

The network node 106 may be any kind of network node that can provide wireless access to the one or more wireless device 110, 112, 114 alone or in combination with another network node. Examples of network nodes 106 are a base station (BS), a radio BS, a base transceiver station, a BS controller, a network controller, a Node B (NB), an evolved Node B (eNB), a gNodeB (gNB), a Multi-cell/multicast Coordination Entity, a relay node, an access point (AP), a radio AP, a remote radio unit (RRU), a remote radio head (RRH) and a multi-standard BS (MSR BS).

The one or more wireless device 110, 112, 114 may be any type of device capable of wirelessly communicating with a network node 106 using radio signals. For example, the one or more wireless device 110, 112, 114 may be a User Equipment (UE), a machine type UE or a UE capable of machine to machine (M2M) communication, a sensor, a tablet, a mobile terminal, a smart phone, a laptop embedded equipped (LEE), a laptop mounted equipment (LME), a USB dongle, a Customer Premises Equipment (CPE), an Internet of Things (IoT) device, etc.

FIG. 2 shows an embodiment of a RIS unit 120 that is adapted for use in energy harvesting mode in accordance with embodiments of the invention. The RIS unit 120 comprises, in addition to the features mentioned in relation to FIG. 1, also a measurement unit 126, an energy harvesting device 127 aka energy harvester, and a power supply 128. Two or more of the measurement unit 126, the energy harvester 127 and the power supply 128 may be integrated in the same physical unit or box.

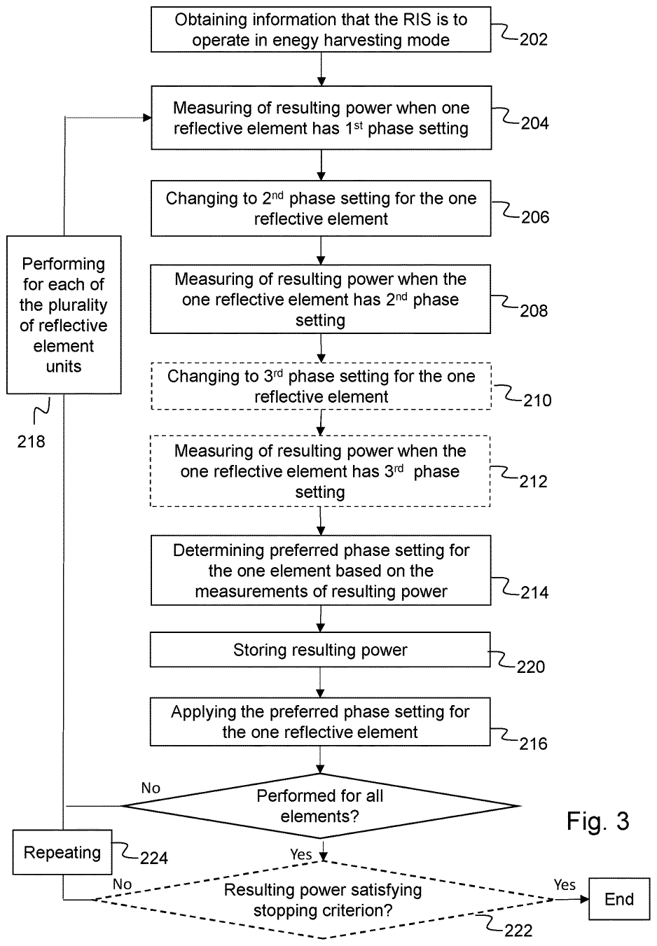

FIG. 3, in conjunction with FIG. 2, describes a method performed by a RIS unit 120 of a wireless communication network 100, for harvesting energy. The RIS unit 120 comprises a RIS 121 that has a plurality of reflective element units 124. Each of the plurality of reflective element units 124 is independently controllable regarding phase setting and is independently controllable in relation to the other of the plurality of reflective element units. The method comprises obtaining 202, from the wireless communication network 100, information that the RIS unit 120 is to operate in an energy harvesting mode. The method further comprises, after the obtaining, measuring 204 a resulting power-related quantity of one or more wireless signals received by the RIS 121 from one or more transmitters 106, when one of the plurality of reflective element units 124 has a first phase setting, the resulting power-related quantity being a power-related quantity of a combined signal combined by the one or more wireless signals received at the plurality of reflective element units 124. The method further comprises changing phase setting 206 of the one of the plurality of reflective element units 124 from the first phase setting to a second phase setting different from the first phase setting and measuring 208 the resulting power-related quantity when the one reflective element unit 124 has the second phase setting. The method further comprises determining 214 a preferred phase setting for the one reflective element unit 124 based on the measured resulting power-related quantity for the first and second phase settings, the preferred phase setting being determined to give a highest possible resulting power for the combined signal, and applying 216 the determined preferred phase setting for the one reflective element unit 124. The method further comprises performing 218, for each of the plurality of reflective element units 124, one after the other, and with the applied determined preferred phase settings, the steps of measuring 204 the resulting power-related quantity for the first phase setting, changing 206 phase setting to the second phase setting, measuring 208 the resulting power-related quantity for the second phase setting, determining 214 the preferred phase setting based on the measured resulting power-related quantity for the first and second phase settings, and applying 216 the determined preferred phase setting. The method further comprises storing 220 the resulting power of the combined signal at the power supply 128 of the RIS unit 120.

In other words, for one of the reflective element units 124 of the RIS 121, a resulting power-related quantity value, in the following exemplified with power, of a combined RIS-signal is measured for at least two different phase settings of the reflective element unit 124. The combined signal is a signal that is obtained when the individual signals received at each of the reflective element units, or at least a plurality of all reflective element units, are combined into one signal. The individual signals have, or at least they can have, different phase shifts when combined. Based on the measurements of the resulting power at the at least two different phase settings for the one reflective element unit, and knowledge of the phase settings, a phase setting, here called preferred phase setting, for the one reflective element unit 124 is determined that can be expected to give the highest resulting power for the combined signal. After this is done for the one reflective element unit of the RIS 121, the same process is repeated, or performed, for each of the plurality of reflective element units, one at a time, applying the determined preferred phase settings for the reflective element unit(s) that have/has already gone through the process of determining and applying a preferred phase setting.

As a result, the RIS unit 120 can efficiently harvest energy from incoming signals. Further, only power-related quantities of the combined signal need to be measured in order to achieve an efficient energy harvesting. In other words, in this method, it is not necessary to measure phase as well as a power-related quantity. This is advantageous as the RIS unit 120 does not need extra hardware to measure only the power-related quantity, which is necessary when joint power and phase are measured. Further, with the above method, the RIS unit 120 configures the RIS 121 using a sequence of power-related quantity measurements without needing to interact with the transmitter, i.e., the network node 106, after obtaining 202 the information to start working in energy harvesting mode. Further, the method is scalable with the number of reflective element units 124 of the RIS 121, as the complexity of the method increases linearly with the number of reflective element units. This solution is an important step towards realizing a self-sustainable RIS unit 120 that can harvest energy from signals of surrounding one or more transmitters using a low number of hardware components and without knowing the number of transmitters and their positions.

A “reflective element unit” 124 signifies a unit comprising one or more reflective elements. One reflective element unit is independently controllable in relation to other reflective element units. One reflective element unit comprises one or more reflective elements that cannot be phase controlled mutually independent, i.e. they have to be controlled as one unit. One reflective element unit could also comprise a plurality of elements for which it has been decided that they are to be controlled as one reflective element unit.

The information that the RIS unit 120 is to operate in energy harvesting mode can be obtained 202 by being received from a node of the wireless communication network 100, for example from a network node in which one of the one or more transmitters is residing, such as the network node 106. The information may be received from, or at least originate from a network entity manager. The network entity manager may be a part of the network node 106 or a separate entity situated anywhere in the wireless communication network 100 or even in a cloud network. There is a wireless link between the network node 106 and the RIS unit 120 that can be used for normal RIS operation, i.e., signal receiving and reflecting, or for energy harvesting. The information that the RIS is to operate in energy harvesting mode may be sent over the wireless link used for normal RIS operation or the information may be sent over a separate link, separate from the wireless link used for normal RIS operation. The link used for transferring information that the RIS unit is to operate in energy harvesting mode does not need to have a large capacity.

The “power-related quantity” signifies any quantity that is directly related to power, such as power or signal strength/amplitude. The one or more transmitters from which the one or more wireless signals are received by the RIS 121 could be or comprise transmitters of a network node that is specifically arranged to transmit signals to wireless devices via the RIS 121. However, the one or more transmitters may comprise any transmitter that happens to transmit signals that can be captured by the RIS 121, such as other neighboring network nodes or even wireless devices. The resulting power may be stored while the method is performed, and/or the resulting power may be stored after the method has been performed. In the disclosure, a “RIS” is the actual surface with its reflective element units. Further, a “RIS unit” comprises the RIS and its reflective element units as well as other functionality of the RIS, such as one or more of the power supply 128, the measurement unit 126, and the energy harvester 127. The other functionality may be arranged as separate functional boxes, and/or integrated in the RIS 121.

According to an embodiment, the method further comprises changing phase setting 210 of the one reflective element unit 124 from the second phase setting to a third phase setting different from the first phase setting and from the second phase setting, and measuring 212 the resulting power-related quantity, when the one reflective element unit 124 has the third phase setting. Further, the preferred phase setting for the one reflective element unit is determined 214 based on the measured resulting power-related quantity for the first, second and third phase settings. Further, the steps of changing 210 phase setting to the third phase setting and measuring 212 the resulting power-related quantity for third phase setting are performed 218 for each of the plurality of reflective element units 124, one after the other, and with the applied determined preferred phase setting, as well as the steps of measuring 204 the resulting power-related quantity for the first phase setting, changing 206 phase setting to the second phase setting, measuring 208 the resulting power-related quantity for the second phase setting, determining 214 the preferred phase setting based on the measured resulting power-related quantity for the first, second and third phase settings, and applying 216 the determined preferred phase settings.

By adding a third phase setting different than the first and second phase settings and measuring the power-related quantity at this third phase setting as well, for each reflective element unit, an even higher resulting power can be stored as compared to using measurements at two phase settings per reflective element unit. By measuring at a third phase setting in addition to the measurement at the first and second phase settings, the signal dimensions are better observed, which may result in a better aligning of the phase settings of the reflective element units and a higher resulting power compared to using measurements at only two different phase settings. It may be possible to add a fourth or even fifth phase setting and measure on those phase settings as well in a similar way. This may be of interest for example in noisy scenarios. Further, the number of measurements performed at each phase settings can be one or more. The accuracy may increase when more measurements are performed per phase setting, especially in noisy scenarios.

According to another embodiment, the method further comprises repeating 224 the steps of measuring 204 the resulting power-related quantity for the first phase setting, changing 206 phase setting to the second phase setting, measuring 208 the resulting power-related quantity for the second phase setting, determining 214 a preferred phase setting based on the measured resulting power-related quantity for the first and second phase settings, and applying 216 the determined preferred phase setting, as well as the performing 218 of the above steps for each of the plurality of reflective element units 124.

In this embodiment, the whole method described above and in relation to FIG. 3 is repeated once more, i.e., iterated. I.e., after performing the method for each of the plurality of reflective element units, one after the other, the method is repeated at least once for all of the plurality of reflective element units, one after the other. Hereby, an even higher resulting power is achieve compared to the power achieved without such an iteration.

According to an alternative to this embodiment, also the steps of changing 210 phase setting to the third phase setting and measuring 212 the resulting power-related quantity for third phase setting are repeated.

This embodiment defines that measurements are performed of the power-related quantity for three different phase settings per reflective element unit, and this whole method is iterated. Hereby, it can be possible to achieve an even higher resulting power compared to the power achieved by the above embodiments.

According to another embodiment, the method further comprises, after the performing 218 of the steps for each of the plurality of reflective element units 124, determining 222 whether a repetition stopping criterion is satisfied, and performing the repeating 224 only in case the repetition stopping criterion was determined 222 not to be satisfied. The repetition stopping criterion could be a set number of iterations, e.g., 2. Alternatively, the repetition stopping criterion could be a resulting power after an iteration compared to a theoretically optimal resulting power. In other words, if the resulting power after an iteration is above a threshold set in dependence of a theoretically optimal resulting, the method is not repeated.

According to yet another embodiment, the RIS unit 120 comprises an energy harvesting device 127 that receives the combined signal. The energy harvesting device 127 is arranged for harvesting the energy of the combined signal and for leading the harvested energy to the power supply 128 for storage. The energy harvesting device can be any of a broad range of devices especially adapted for harvesting energy from wireless signals, especially from radio frequency RF wireless signals. An advantageous energy harvesting device here considered is a rectenna.

According to an alternative, the RIS 121 has a first surface and an opposite second surface, and the RIS 121 is able to pass the received one or more wireless signals from its first surface through the RIS to its second surface. Further, the energy harvesting device 127 is electrically connected to the second surface for receiving the combined signal. A RIS 121 that is able to pass received wireless signals through itself from its first surface to its second surface may be called a holographic beamforming meta-surface.

According to another alternative, the RIS 121 is designed to reflect the one or more received wireless signals. Further, the energy harvesting device 127 is situated at a position at a distance from the RIS 121 for receiving the reflected one or more wireless signals as the combined signal. Still further, the resulting power-related quantity is measured at the energy harvesting device 127, and the energy harvesting device 127 is electrically connected to the power supply 128. The electrical connection between the energy harvesting device and the power supply may be a cable.

According to yet another embodiment, the RIS 121 further comprises a plurality of second reflective element units, in addition to the plurality of reflective element units 124. Further, that the RIS unit 120 operates in energy harvesting mode means that at least the plurality of reflective element units 124 operate in energy harvesting mode. Still further, the method comprises setting the plurality of second reflective element units to operate in signal reflecting mode at least partly at the same time as the plurality of reflective element units 124 operate in energy harvesting mode. Hereby, a part of the RIS can operate in signal reflecting mode while another part of the RIS operates in energy harvesting mode. Each of the plurality of second reflective element units is independently controllable regarding phase setting and is independently controllable in relation to the other of the plurality of second reflective element units.

According to yet another embodiment, the first and second phase settings are separated by approximately π/2 radians, the second and third phase settings are separated by approximately π/2 radians and the first and third phase settings are separated by approximately IT radians. It has been observed that equally spaces angles are good for performance.

In the following, different embodiments are described. First, a scenario is described. The received power by the energy harvesting unit, i.e., the resulting power of signals combined from the plurality of reflective element units, after filtering has the expression

$$f ( {ϑ}_{1} , {ϑ}_{2} , ... , {ϑ}_{N} ) = {\vert {\sum }_{n = 1}^{N} {z}_{n} {e}^{j {ϑ}_{n}} \vert}^{2} , \qquad ( 1 )$$

where zₙ ∈ [symbol] for each 0≤n≤N. N is the total number of reflective element units in the plurality of reflective element units. Zₙ is a multiplication of channel gains between the transmitter and the energy harvesting unit via RIS element unit n. In other words, Zₙ is a coefficient that accounts for the total amplitude loss and phase shift that the signal gets from the transmitter to the energy harvesting unit via RIS element unit n, except for the adjustable phase shift component. In (1), Zₙ not only includes all channel gains between transmitters and the energy harvester (except the adjustable phase shift ∂ₙ), but also takes into account the transmission power which is assumed to be unknown to the RIS. Also, ∂ₙ is the adjustable phase shift/setting for the nth reflective element unit of the RIS.

As mentioned, we assume that channel state information (CSI) is not available to the RIS unit. This scenario is more general compared to a scenario with coordination between the transmitters and the RIS because the transmitter can even be unaware of the existence of the RIS. The RIS can reconfigure its phase settings and measure the received signal power from the transmitters that are operating at the same band. The measured power in the energy harvesting device is in fact an evaluation of (1).

In this document, a scalable algorithm to maximize the received power without knowing the values of

$${\{ {ϑ}_{n} \}}_{n = 1}^{N}$$

is proposed. For known values of

$${\{ {ϑ}_{n} \}}_{n = 1}^{N} ,$$

the optimal phase variables

$${\{ {ϑ}_{n}^{*} \}}_{n = 1}^{N}$$

that maximize the function ƒ are given by

$${ϑ}_{n}^{*} = {ϑ}_{0} - arg ( {z}_{n} ) , \qquad ( 2 )$$

where ∂₀ ∈ [0,2π) is an arbitrary phase shift.

The values of the

$${\{ {z}_{n} \}}_{n = 1}^{N}$$

depend on the geometry and propagation environment and they are generally estimated by measuring amplitude and phase by RF chain circuits. With an RF chain, one can measure

$${\sum }_{n = 1}^{N} {z}_{n} {e}^{j {ϑ}_{n}} ,$$

which includes both the phase and amplitude, using a sequence of configurations and use this information to identify the estimate zₖ, for example by solving a linear system of equations.

If the RIS unit is not equipped with an RF chain, the RIS unit cannot measure both the amplitude and phase and hence, the values of

$${\{ {z}_{n} \}}_{n = 1}^{N}$$

would be unknown to the RIS. On the other hand, with simple power measurements, the RIS unit can evaluate the function ƒ for each phase configuration. However, the values of phases will remain unknown to the RIS unit.

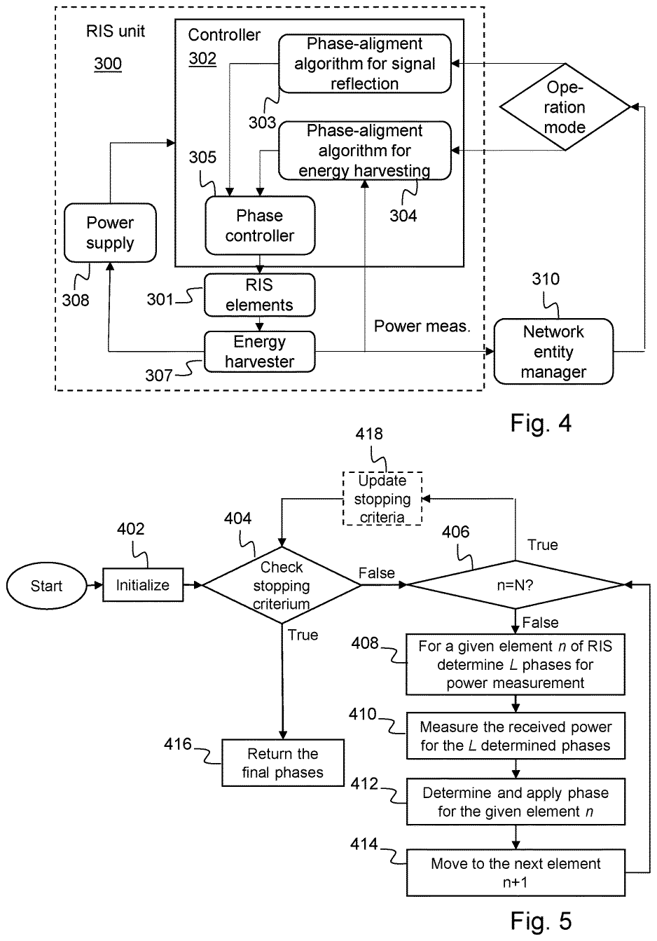

A RIS is initially deployed in a wireless communication network 100 for providing coverage extension to areas that otherwise have poor coverage for wireless communication. If a RIS is equipped with an energy harvester, it can harvest energy from transmitters around it and potentially become energy neutral. In FIG. 4, a possible structure for energy harvesting at a RIS is shown. The RIS unit 300 of FIG. 4 comprises the actual RIS with its reflective elements 301, a RIS controller 302, an energy harvester 307 including a measurement unit and a power supply 308. Further, a network entity manager 310 situated in the wireless communication network 100 can evaluate the network environment, such as but not limited to network demand, Signal to Noise Ratio (SNR), and power measurements from the RIS unit 300 and decide whether the RIS unit 300 should operate to provide data transmission, i.e., to reflect signals, or operate to harvest energy. Within the RIS controller 302, the phase of each element can be determined depending on the use case. When the network entity manager 310 has instructed the RIS unit 302 to operate in signal reflection mode, a phase-alignment algorithm for signal reflection 303 is activated. When the network entity manager 310 has instructed the RIS unit 302 to operate in energy harvesting mode, a phase-alignment algorithm for energy harvesting 304 is activated. A phase controller 305 controls the phase setting of each reflective element 301, or reflective element unit, according to the individual phase setting determined by the respective algorithm 304, 303. The energy harvester 307 can be deployed outside or inside of the RIS, and it can provide the energy harvesting algorithm 304 and the network entity manager 310 with power measurements. The power measurement values can be used by the network entity manager 310 to decide whether the RIS unit 300 is to operate for energy harvesting or data transmission. The power measurements are also used to align the phase of each RIS element for energy harvesting, which will be explained further down. When phases are aligned, the energy harvested by the energy harvester 307 can be fed back to the power supply 308 to be used for supplying the RIS unit with power.

In the following, the phase-alignment algorithm for energy harvesting 304 is described. The algorithm 304 maximizes the received power by elementwise adjustment of the phase settings of the individual reflective element units of the RIS. In general, for each reflective element unit, the phase adjustment requires L measurements. Therefore, for a RIS with N reflective element units, to adjust the phase for all reflective element units once, L×N measurements are required. This process can be repeated iteratively, i.e., the phase for all reflective element units can be adjusted at least one more time, to reduce the gap from an optimal point with maximum possible received power and to satisfy a stopping criterium. The stopping criteria can be e.g., a certain percentage total received power of a theoretical optimal total received power or a total number of repetitions.

FIG. 5 shows an embodiment of a method for the phase adjustment of reflective element units of a RIS for energy harvesting. First, the method initializes 402 RIS parameters such as phases. Then, optionally, a stopping criterium is checked 404, and, also optionally, it is checked 406 whether the number of reflective element units n which has been phase adjusted equals the total number of reflective element units N. Then the method starts with the first reflective element unit of the RIS unit, and L phases are defined 408 for which power measurement is to be performed. L may be for example 3 phases. A combined power is measured 410 for each of the L phases. The combined power is a power that is obtained when signals received at the reflective element units are combined into one signal. Then the phase setting for the first reflective element unit is determined and applied 412 so that the phase ∂₁ of this first reflective element aligns with a complex number wₙ that is defined as

$${w}_{n} := {\sum }_{{k = 1}_{k \neq n}}^{N} {z}_{k} {e}^{j {ϑ}_{k}} . \qquad ( 3 )$$

At this stage, the method solves the following sub-problem which aims to maximize the function

$${f}_{n} ( {ϑ}_{n} ) := {\vert {w}_{n} + {z}_{n} {e}^{j {ϑ}_{n}} \vert}^{2} , \qquad ( 4 )$$

by evaluating its value at certain points.

Here the function ƒₙ differs from ƒ defined in (1) as it only takes one input variable for the phase of the RIS element n and assumes that the other phases are fixed. In some cases, zₙ does not describe the channel for a single reflective element, but the combined channel of a group of neighboring reflective elements. We can for example group the reflective elements together when the RIS array geometry requires the elements to have similar optimal phase settings. Therefore, a reflective element unit is a group of one or more reflective elements that are set to have the same phase. The required signaling for configuration is then proportional to the number of groups.

Note that for each reflective element unit, the phase of the reflective element unit is aligned in a way that the power of the combined signal is maximized. Hence, it is different than maximizing the objective problem for each reflective element unit. The idea is to sequentially align the phase of each reflective element unit as the contribution of the element unit to maximize the utility function, rather than maximizing the contribution to the utility function. The complexity of such operation is O(N). One can cluster reflective element units of the RIS and decide on the phase settings for all reflective element units residing in the same cluster. Although this approach can reduce the number of measurements and operations, it does not reduce the complexity as it remains O(N), with N denoting the number of clusters. The proposed approach can be used for such a clustering approach, if each cluster represents a reflective element unit in the RIS. As an extension of this idea, a subset of reflective element units can be grouped as operating for signal reflection RIS and the rest of the reflective element units can be grouped as operating for energy harvesting.

To find the optimal phase settings

$${ϑ}_{n}^{*}$$

for the sub-problem it is only needed to evaluate ƒₙ at three different phases of one reflective element unit. In other words, then L=3. According to a preferred embodiment, the phases are

$$0 , \frac{π}{2} ,$$

and π.

The method evaluates the function at given phase to obtain the following equations

$${y}_{1} = {f}_{n} ( 0 ) = {\vert {w}_{n} \vert}^{2} + {\vert {z}_{n} \vert}^{2} + 2 \text{?} ( {w}_{n} {z}_{n}^{*} ) , \qquad ( 5 )$$

$${y}_{2} = {f}_{n} ( \frac{π}{2} ) = {\vert {w}_{n} \vert}^{2} + {\vert {z}_{n} \vert}^{2} + 2 \text{?} ( {w}_{n} {z}_{n}^{*} ) , \qquad ( 6 )$$

$${y}_{3} = {f}_{n} ( π ) = {\vert {w}_{n} \vert}^{2} + {\vert {z}_{n} \vert}^{2} - 2 \text{?} ( {w}_{n} {z}_{n}^{*} ) . \qquad ( 7 )$$

From (5) and (7) we have

$$\text{?} ( {w}_{n} {z}_{n}^{*} ) = \frac{{y}_{1} - {y}_{3}}{4} , and \qquad ( 8 )$$

$${\vert {w}_{n} \vert}^{2} + {\vert {z}_{n} \vert}^{2} = \frac{{y}_{1} + {y}_{3}}{2} . \qquad ( 9 )$$

Similarly, from (6) and (9), we have

$$\text{?} ( {w}_{n} {z}_{n}^{*} ) = \frac{2 {y}_{2} - {y}_{1} - {y}_{3}}{4} . \qquad ( 10 )$$

Also, from (2) we have

$$\begin{matrix}{ϑ}_{n}^{*} = {ϑ}_{0} - arg ( {z}_{n} ) , \\ = arg ( {w}_{n} ) - arg ( {z}_{n} ) , \\ = arg ( {w}_{n} {z}_{n}^{*} ) , \\ = arg ( \text{?} ( {w}_{n} {z}_{n}^{*} ) + j \text{?} ( {w}_{n} {z}_{n}^{*} ) ) .\end{matrix} \qquad ( 11 )$$

Finally, from (8), (10) and (11), the optimal phase

$${ϑ}_{n}^{*}$$

for the sub-problem becomes

$${ϑ}_{n}^{*} = arg ( {y}_{1} - {y}_{3} + j ( 2 {y}_{2} - {y}_{1} - {y}_{3} ) ) . \qquad ( 12 )$$

The optimal phase of

$${ϑ}_{n}^{*}$$

is applied to element n of the RIS. Then the method moves 414 to the next element n+1. The same procedure is followed until n=N 406 so that the algorithm has applied the elementwise phases for all reflective elements that are used for energy harvesting.

When the elementwise phases have been determined for the N elements, a stopping criterium 404 may be checked. The stopping criterium may be set to a maximum number of iterations of the process of elementwise determination of the phases. The maximum number of iterations may according to an embodiment be set to 2. Alternatively, the stopping criterium may be set so that the process stops when the harvested power becomes larger than a threshold. When the stopping criterium 404 is fulfilled, the process ends and the finally determined phases are returned 416, i.e., used by the phase controller 305. According to an embodiment, the stopping criterium may be updated 418 during the process, for example, the stopping criterium may be changed depending on for example changed communication channel conditions. According to another embodiment, the stopping criterium is defined beforehand.

In the above-described embodiment, we are dealing with a problem with 2N unknowns (i.e., real and imaginary parts of

$${\{ {z}_{n} \}}_{n = 1}^{N} ) .$$

Therefore, in order to find the exact solution, we need at least 2N measurements with different phase configurations. Each measurement provides a quadratic equation, and we should solve a system of 2N quadratic equations with 2N unknowns, which is very complicated to solve. However, the complexity of the proposed algorithm is O(N), which means the complexity is linearly proportional to the number of RIS elements. Moreover, based on our simulation, after one iteration over all elements, i.e., 3N measurements, i.e., no repetition over the N elements, we reach to more than 99% of the maximum feasible receive power for more than 90% of the channel realizations.

In the following, an exemplary algorithm called Algorithm 1 is described. The Algorithm 1 describes one possible implementation of the proposed method in detail. The input of the Algorithm 1 is the number of iterations M and the output is the near optimal phase vector ∂*. At the iteration n in the inner loop, the algorithm aligns the phase of the reflective element unit n with the complex number defined in (3) and continues this process for all reflective element units and for M iterations. Our simulation results show that after the first iteration, the received power reaches to 97% of the theoretical maximum value, and after the second iteration, the received power reaches to 99.99% of the theoretical maximum value.

Algorithm 1: A phase-alignment algorithm for power maximization

```
  Input: The number of RIS elements, i.e., reflective element units N, and
  the number of iterations M
  Output: Near-optimal phase vector ϑ* that maximizes the received
  power, i.e. total received power of a combined signal combined by
  one or more wireless signals received at the plurality of reflective
  element units.
  Initialize: ϑ ← ϑ₀, m ← 0, and eₙ is a vector, where the component
  n is one and all other components are zero.
  While m < M do
    m ← m + 1;
    n ← 1;
    while n ≤ N do
      y₁ ← the measured power for the phase configuration ϑ;
      ${y}_{2} ⟵ the measured power for the phase configuration ϑ + \frac{π}{2} {e}_{n} ;$
      y₃ ← the measured power for the phase configuration ϑ + πeₙ;
      ϑ ← ϑ + arg(y₁ − y₃ + j(2y₂ − y₁ − y₃)eₙ)
      n ← n + 1;
  end
  ϑ* ← ϑ;
```

In the following, two different possible use cases are described. Please note that a RIS is usually used in an environment where a direct wireless communication channel between the transmitter and the receiver, e.g., between a network node and one or more wireless devices, is weak. However, the RIS is deployed in a place where the channel between the transmitter and the RIS and the channel between the RIS and the receiver are both strong. Hence, low SNR of the channel from the transmitter to the receiver does not translate to low SNR from the transmitter to the RIS. As the deployment strategy implies a high signal strength at the RIS, the SNR can be sufficiently high to configure the RIS as proposed in any of the embodiments of this disclosure.

A RIS usually refers to a meta-surface with elements that are arranged only to reflect the incident electromagnetic (EM) waves, irrespective whether the RIS is used in signal reflection mode or energy harvesting mode. Such a RIS is called a first type of RIS and is shown in FIG. 7. The first type of RIS will be discussed further down.

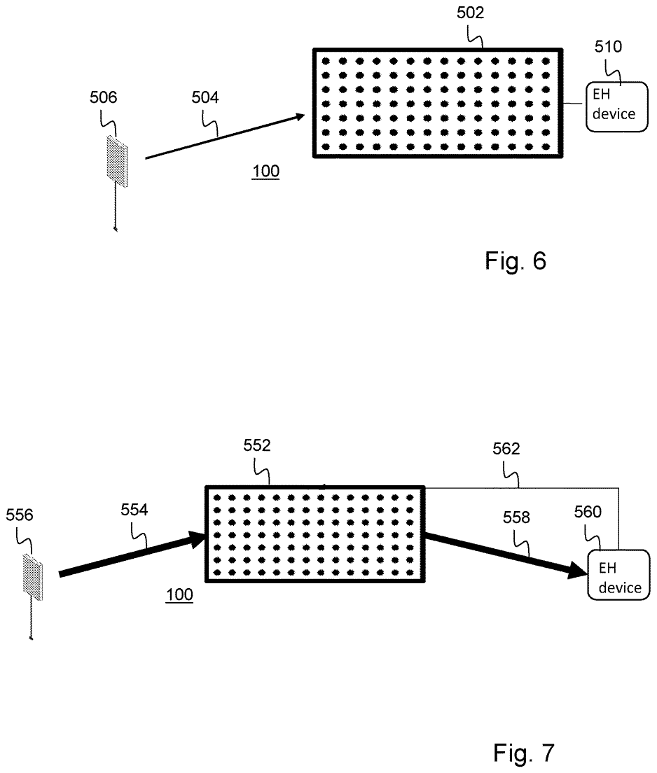

There is also a second type of RIS having a meta-surface called holographic beamforming meta-surface that can pass the incident EM waves through the RIS from one side to an opposite second surface. The second type of RIS contains an internal distribution network that superimposes the signals. The metamaterial in the distribution network can add adjustable phase shifts, similar as for the first type of RIS but with a different implementation. FIG. 6 shows an example of the second type of RIS 502 realized as a holographic beamforming meta-surface. Such a second type of RIS 502 can either reflect or receive incident EM waves 504 sent by a transmitter 506. The second type of RIS 502 is instructed to receive the incident EM waves 504 when it is set in energy harvesting mode. When the second type of RIS 502 is in energy harvesting mode, it combines the received EM waves at each reflective element having individual reflective element phase shifts, which may be similar to analog phased arrays, and collects the combined EM waves/signals at an energy harvester 510. In other words, the signal/EM waves combined at the second type of RIS 502 is led to the energy harvester 510. The energy harvester 510 may be integrated in the RIS 502 or arranged as a separate unit connected to the RIS via e.g., a cable through which the combined signal/EM waves is led. The method proposed in any of the embodiments of this disclosure can be used to determine the individual reflective element phase settings for power maximization. In FIG. 6, h=[h₁, . . . , h_{N}]^{T} describes the channel between the transmitter and the reflective/meta-surface elements. The phase settings of the reflective/meta-surface elements are described as

$${ω}_{θ} = [ \begin{matrix}{e}^{- j {θ}_{1}} \\ ⋮ \\ {e}^{- j {θ}_{N}}\end{matrix} ] .$$

With such a holographic beamforming meta-surface, a single harvesting unit can be used, which harvests the energy of the combined signals of the reflective/meta-surface elements with constructive phase shifts.

For the first type of RIS, which is shown in FIG. 7, the RIS can only reflect the incoming EM waves. For this first type of RIS 552, an energy harvesting (EH) device 560 is positioned in front of the RIS at a distance from the RIS 552. When the first type of RIS 552 works in energy harvesting mode, the phases of its reflective element units are aligned such that the reflected EM waves combine constructively at the point where the energy harvesting device 560 is located. In other words, incoming EM waves 554 originating from a transmitter 556 are reflected by the reflective element units of the first type of RIS 552, which reflective element units have such phase settings that outgoing EM waves 558 combine constructively at the EH device 560. The EH device 560 then can return the harvested energy to the RIS 552 via a cable 562. Here h=[h₁, . . . , h_{N}]^{T} describes the channel between the transmitter 556 and the first type of RIS 552, g=[g₁, . . . , g_{N}]^{T} describes the channel between the first type of RIS 552 and the EH device 560, and

$${ω}_{θ} = [ \begin{matrix}{e}^{- j {θ}_{1}} \\ ⋮ \\ {e}^{- j {θ}_{N}}\end{matrix} ]$$

is the phase setting vector. The method proposed in any of the embodiments of this disclosure can be used to determine the individual reflective element phase settings for power maximization. With optimal ω_{θ}, a constructive addition of the signals occurs at the location of the energy harvesting (EH) device.

Regardless of type of RIS, the RIS can use the harvested energy to sustain its operation or, if the energy is not enough, it can at least decrease the consumption from other energy sources, that is at least one step toward a self-sustainable RIS unit.

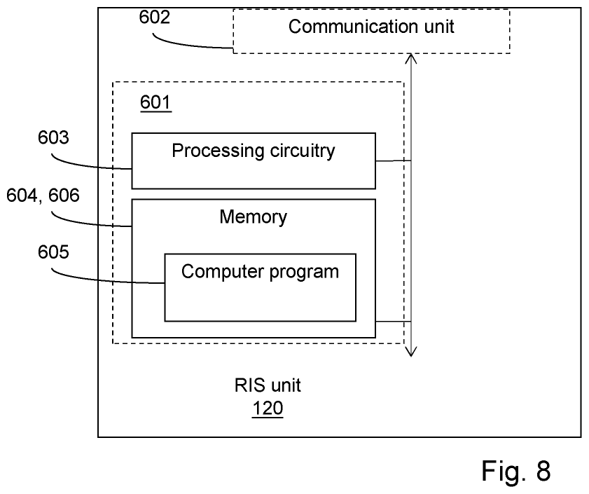

FIG. 8, in conjunction with FIG. 2, describes a RIS unit 120 configured to operate in a wireless communication network 100, and configured for harvesting energy. The RIS unit 120 comprises a RIS 121 that has a plurality of reflective element units 124. Each of the plurality of reflective element units 124 is independently controllable regarding phase setting and is independently controllable in relation to the other of the plurality of reflective element units. The RIS unit 120 comprises a processing circuitry 603 and a memory 604, said memory contains instructions executable by said processing circuitry, whereby the RIS unit 120 is operative for obtaining, from the wireless communication network 100, information that the RIS unit 120 is to operate in an energy harvesting mode, The RIS unit 120 is further operative for, after the obtaining measuring a resulting power-related quantity of one or more wireless signals received by the RIS 121 from one or more transmitters 106, when one of the plurality of reflective element units 124 has a first phase setting, the resulting power-related quantity being a power-related quantity of a combined signal combined by the one or more wireless signals received at the plurality of reflective element units 124, changing phase setting of the one of the plurality of reflective element units 124 from the first phase setting to a second phase setting different from the first phase setting, and measuring the resulting power-related quantity, when the one reflective element unit 124 has the second phase setting. The RIS unit 120 is further operative for determining a preferred phase setting for the one reflective element unit 124 based on the measured resulting power-related quantity for the first and second phase settings, the preferred phase setting being determined to give a highest possible resulting power for the combined signal. The RIS unit 120 is further operative for applying the determined preferred phase setting for the one reflective element unit 124. The RIS unit 120 is further operative for performing, for each of the plurality of reflective element units 124, one after the other, and with the applied determined preferred phase settings, the steps of measuring the resulting power-related quantity for the first phase setting, changing phase setting to the second phase setting, measuring the resulting power-related quantity for the second phase setting, determining the preferred phase setting based on the measured resulting power-related quantity for the first and second phase settings, and applying the determined preferred phase setting. The RIS unit 120 is further operative for storing the resulting power of the combined signal at a power supply 128 of the RIS unit 120.

According to an embodiment, the RIS unit 120 is further operative for changing phase setting of the one reflective element unit 124 from the second phase setting to a third phase setting different from the first phase setting and from the second phase setting, and measuring the resulting power-related quantity, when the one reflective element unit 124 has the third phase setting. Further, the RIS unit 120 is operative for determining the preferred phase setting for the one reflective element unit based on the measured resulting power-related quantity for the first, second and third phase settings, and performing the steps of changing phase setting to the third phase setting and measuring the resulting power-related quantity for third phase setting for each of the plurality of reflective element units 124, one after the other, and with the applied determined preferred phase settings, as well as the steps of measuring the resulting power-related quantity for the first phase setting, changing phase setting to the second phase setting, measuring the resulting power-related quantity for the second phase setting, determining the preferred phase setting based on the measured resulting power-related quantity for the first, second and third phase settings, and applying the determined preferred phase setting.

According to another embodiment, the first and second phase settings are separated by approximately π/2 radians, the second and third phase settings are separated by approximately π/2 radians and the first and third phase settings are separated by approximately IT radians.

According to yet another embodiment, the RIS unit 120 is operative for repeating the steps of measuring the resulting power-related quantity for the first phase setting, changing phase setting to the second phase setting, measuring the resulting power-related quantity for the second phase setting, determining a preferred phase setting based on the measured resulting power-related quantity for the first and second phase settings, and applying the determined preferred phase setting, as well as the performing of the above steps for each of the plurality of reflective element units 124.

According to an alternative of this embodiment, the RIS unit 120 is operative to also repeat the steps of changing phase setting to the third phase setting and measuring the resulting power-related quantity for third phase setting.

According to another embodiment, the RIS unit 120 is further operative for, after the performing of the steps for each of the plurality of reflective element units, determining whether a repetition stopping criterion is satisfied, and for performing the repeating only in case the repetition stopping criterion was determined not to be satisfied.

According to another embodiment, the RIS unit 120 comprises an energy harvesting device 127 arranged to receive the combined signal, the energy harvesting device 127 being arranged for harvesting the energy of the combined signal and for leading the harvested energy to the power supply 128 for storage.

According to an alternative of this embodiment, the RIS 121 has a first surface and an opposite second surface, and the RIS 121 is able to pass the received one or more wireless signals from its first surface through the RIS to its second surface. Further, the energy harvesting device 127 is electrically connected to the second surface for receiving the combined signal.

According to another alternative of this embodiment, the RIS 121 is designed to reflect the one or more received wireless signals. Further, the energy harvesting device 127 is situated at a position at a distance from the RIS 121 for receiving the reflected one or more wireless signals as the combined signal. Further, the RIS unit 120 is operative for measuring the resulting power-related quantity at the energy harvesting device 127, and the energy harvesting device 127 is electrically connected to the power supply 128.

According to yet another embodiment, the RIS 121 further comprises a plurality of second reflective element units, in addition to the plurality of reflective element units 124. Further, the RIS unit 120 operating in energy harvesting mode means at least the plurality of reflective element units 124 operating in energy harvesting mode. Still further, the RIS unit 120 is operative for setting the plurality of second reflective element units to operate in signal reflecting mode at least partly at the same time as the plurality of reflective element units 124 operate in energy harvesting mode.

According to other embodiments, the RIS unit may further comprise a communication unit 602, which may be considered to comprise conventional means for reception of the instruction to work in energy harvesting mode. The instructions executable by said processing circuitry 603 may be arranged as a computer program 605 stored e.g. in said memory 604. The processing circuitry 603 and the memory 604 may be arranged in a sub-arrangement 601. The sub-arrangement 601 may be a micro-processor and adequate software and storage therefore, a Programmable Logic Device, PLD, or other electronic component(s)/processing circuit(s) configured to perform the methods mentioned above. The processing circuitry 603 may comprise one or more programmable processor, application-specific integrated circuits, field programmable gate arrays or combinations of these adapted to execute instructions.

The computer program 605 may be arranged such that when its instructions are run in the processing circuitry 603, they cause the RIS unit 120 to perform the steps described in any of the described embodiments of the RIS unit 120 and its method. The computer program 605 may be carried by a computer program product connectable to the processing circuitry 603. The computer program product may be called a computer-readable storage medium 606. The computer-readable storage medium 606 may be the memory 604, or at least arranged in the memory. The memory 604 may be realized as for example a Random-access memory (RAM), Read-Only Memory (ROM) or an Electrical Erasable Programmable ROM (EEPROM). In some embodiments, a carrier may contain the computer program 605. The carrier may be one of an electronic signal, an optical signal, an electromagnetic signal, a magnetic signal, an electric signal, a radio signal, a microwave signal, or the computer readable storage medium 606. The computer-readable storage medium 606 may be e.g., a CD, DVD or flash memory, from which the program could be downloaded into the memory 604. Alternatively, the computer program 605 may be stored on a server or any other entity to which the RIS unit 120 has access via the communication unit 602. The computer program 605 may then be downloaded from the server into the memory 604.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method performed by a reconfigurable intelligent surface unit of a wireless communication network, for harvesting energy, the RIS unit comprising a RIS that has a plurality of reflective element units, wherein each of the plurality of reflective element units is independently controllable regarding phase setting and is independently controllable in relation to the other of the plurality of reflective element units, the method comprising:
obtaining, from the wireless communication network, information that the RIS unit is to operate in an energy harvesting mode, and after the obtaining:
measuring a resulting power-related quantity of one or more wireless signals received by the RIS from one or more transmitters, when one of the plurality of reflective element units has a first phase setting, the resulting power-related quantity being a power-related quantity of a combined signal combined by the one or more wireless signals received at the plurality of reflective element units;
changing phase setting of the one of the plurality of reflective element units from the first phase setting to a second phase setting different from the first phase setting,
measuring the resulting power-related quantity, when the one reflective element unit has the second phase-setting, setting;
determining a preferred phase setting for the one reflective element unit based on the measured resulting power-related quantity for the first and second phase settings, the preferred phase setting being determined to give a highest possible resulting power for the combined signal;
applying the determined preferred phase setting for the one reflective element unit;
performing, for each of the plurality of reflective element units, one after the other, and with the applied determined preferred phase settings, the steps of measuring the resulting power-related quantity for the first phase setting, changing phase setting to the second phase setting, measuring the resulting power-related quantity for the second phase setting, determining the preferred phase setting based on the measured resulting power-related quantity for the first and second phase settings, and applying the determined preferred phase setting, and; and
storing the resulting power of the combined signal at a power supply of the RIS unit.

2. The method of claim 1, wherein
the method further comprises:
changing phase setting of the one reflective element unit from the second phase setting to a third phase setting different from the first phase setting and from the second phase setting; and
measuring the resulting power-related quantity, when the one reflective element unit has the third phase setting,
the preferred phase setting for the one reflective element unit is determined based on the measured resulting power-related quantity for the first, second and third phase settings, and
the steps of changing phase setting to the third phase setting and measuring the resulting power-related quantity for third phase setting are performed for each of the plurality of reflective element units, one after the other, and with the applied determined preferred phase settings, as well as the steps of measuring the resulting power-related quantity for the first phase setting, changing phase setting to the second phase setting, measuring the resulting power-related quantity for the second phase setting, determining the preferred phase setting based on the measured resulting power-related quantity for the first, second and third phase settings, and applying the determined preferred phase setting.

3. The method of claim 2, wherein
the first and second phase settings are separated by approximately π/2 radians, the second and third phase settings are separated by approximately π/2 radians and the first and third phase settings are separated by approximately π radians.

4. The method of claim 1, wherein
the method further comprises repeating the steps of measuring the resulting power-related quantity for the first phase setting, changing phase setting to the second phase setting, measuring the resulting power-related quantity for the second phase setting, determining a preferred phase setting based on the measured resulting power-related quantity for the first and second phase settings, and applying the determined preferred phase setting, as well as the performing of the above steps for each of the plurality of reflective element units.

5. The method of claim 2, wherein also the steps of changing phase setting to the third phase setting and measuring the resulting power-related quantity for third phase setting are repeated.

6. The method of claim 5, wherein
the method further comprises after the performing of the steps for each of the plurality of reflective element units, determining whether a repetition stopping criterion is satisfied, and performing the repeating only in case the repetition stopping criterion was determined not to be satisfied.

7. The method of claim 1, wherein
the RIS unit comprises an energy harvesting device that receives the combined signal, the energy harvesting device being arranged for harvesting the energy of the combined signal and for leading the harvested energy to the power supply for storage.

8. The method of claim 7, wherein
the RIS has a first surface and an opposite second surface, and the RIS is able to pass the received one or more wireless signals from its first surface through the RIS to its second surface, and the energy harvesting device is electrically connected to the second surface for receiving the combined signal.

9. The method of claim 7, wherein
the RIS is designed to reflect the one or more received wireless signals, and wherein the energy harvesting device is situated at a position at a distance from the RIS for receiving the reflected one or more wireless signals as the combined signal, and wherein the resulting power-related quantity is measured at the energy harvesting device, and the energy harvesting device is electrically connected to the power supply.

10. The method of claim 1, wherein
the RIS further comprises a plurality of second reflective element units, in addition to the plurality of reflective element units, wherein the RIS unit operating in energy harvesting mode means at least the plurality of reflective element units operating in energy harvesting mode, the method further comprises:
setting the plurality of second reflective element units to operate in signal reflecting mode at least partly at the same time as the plurality of reflective element units operate in energy harvesting mode.

11. A reconfigurable intelligent surface unit configured to operate in a wireless communication network, and configured for harvesting energy, the RIS unit comprising:
a RIS comprising a plurality of reflective element units, wherein each of the plurality of reflective element units is independently controllable regarding phase setting and is independently controllable in relation to the other of the plurality of reflective element units;
processing circuitry; and memory containing instructions executable by the processing circuitry, wherein the RIS unit is operable to perform a method comprising:
obtaining, from the wireless communication network, information that the RIS unit is to operate in an energy harvesting mode, and after the obtaining:
measuring a resulting power-related quantity of one or more wireless signals received by the RIS from one or more transmitters, when one of the plurality of reflective element units has a first phase setting, the resulting power-related quantity being a power-related quantity of a combined signal combined by the one or more wireless signals received at the plurality of reflective element units;
changing phase setting of the one of the plurality of reflective element units from the first phase setting to a second phase setting different from the first phase setting,
measuring the resulting power-related quantity, when the one reflective element unit has the second phase setting;
determining a preferred phase setting for the one reflective element unit based on the measured resulting power-related quantity for the first and second phase settings, the preferred phase setting being determined to give a highest possible resulting power for the combined signal;
applying the determined preferred phase setting for the one reflective element unit;
performing, for each of the plurality of reflective element units, one after the other, and with the applied determined preferred phase settings, the steps of measuring the resulting power-related quantity for the first phase setting, changing phase setting to the second phase setting, measuring the resulting power-related quantity for the second phase setting, determining the preferred phase setting based on the measured resulting power-related quantity for the first and second phase settings, and applying the determined preferred phase setting; and
storing the resulting power of the combined signal at a power supply of the RIS unit.

12. The RIS unit of claim 11, wherein
the method further comprises:
changing phase setting of the one reflective element unit from the second phase setting to a third phase setting different from the first phase setting and from the second phase setting; and
measuring the resulting power-related quantity, when the one reflective element unit has the third phase setting,
the preferred phase setting for the one reflective element unit is determined based on the measured resulting power-related quantity for the first, second and third phase settings, and
the steps of changing phase setting to the third phase setting and measuring the resulting power-related quantity for third phase setting are performed for each of the plurality of reflective element units, one after the other, and with the applied determined preferred phase settings, as well as the steps of measuring the resulting power-related quantity for the first phase setting, changing phase setting to the second phase setting, measuring the resulting power-related quantity for the second phase setting, determining the preferred phase setting based on the measured resulting power-related quantity for the first, second and third phase settings, and applying the determined preferred phase setting.

13. The RIS unit of claim 12, wherein
the first and second phase settings are separated by approximately π/2 radians, the second and third phase settings are separated by approximately π/2 radians and the first and third phase settings are separated by approximately π radians.

14. The RIS unit of claim 11, wherein
the RIS unit is further operative for repeating the steps of measuring the resulting power-related quantity for the first phase setting, changing phase setting to the second phase setting, measuring the resulting power-related quantity for the second phase setting, determining a preferred phase setting based on the measured resulting power-related quantity for the first and second phase settings, and applying the determined preferred phase setting, as well as the performing of the above steps for each of the plurality of reflective element units.

15. The RIS unit of claim 12, wherein
the RIS unit is further operative to also repeat the steps of changing phase setting to the third phase setting and measuring the resulting power-related quantity for third phase setting.

16. The RIS unit of claim 15, wherein
after the performing of the steps for each of the plurality of reflective element units, the RIS unit determines whether a repetition stopping criterion is satisfied, and performs the repeating only in case the repetition stopping criterion was determined not to be satisfied.

17. The RIS unit of claim 11, wherein
the RIS unit comprises an energy harvesting device arranged to receive the combined signal, the energy harvesting device being arranged for harvesting the energy of the combined signal and for leading the harvested energy to the power supply for storage.

18. The RIS unit of claim 17, wherein
the RIS has a first surface and an opposite second surface, and the RIS is able to pass the received one or more wireless signals from its first surface through the RIS to its second surface, and the energy harvesting device is electrically connected to the second surface for receiving the combined signal.

19. The RIS unit of claim 17, wherein
the RIS is designed to reflect the one or more received wireless signals, and wherein the energy harvesting device is situated at a position at a distance from the RIS for receiving the reflected one or more wireless signals as the combined signal, and wherein the RIS unit is operative for measuring the resulting power-related quantity at the energy harvesting device, and the energy harvesting device is electrically connected to the power supply.

20. The RIS unit of claim 11, wherein
the RIS further comprises a plurality of second reflective element units, in addition to the plurality of reflective element units, wherein the RIS unit operating in energy harvesting mode means at least the plurality of reflective element units operating in energy harvesting mode, the RIS unit further being operative for:
setting the plurality of second reflective element units to operate in signal reflecting mode at least partly at the same time as the plurality of reflective element units operate in energy harvesting mode.

21-22. (canceled)
